(19) United States
(12) Patent Application Publication
(10) Pub. No.: US 2005/0138244 A1
(43) Pub. Date: Jun. 23, 2005

(54) Lower bound algorithm for operation scheduling

(75) Inventors: Jia-Ji Liu, San Jose, CA (US); Frederick C. Chow, Fremont, CA (US)

Correspondence Address: Howard Chen;Suite 2000, One Market, Spear Tower, San Francisco, CA, 94105-1104, US

(73) Assignee: Futurewei Technologies, Inc.

(21) Appl. No.: 10/745,259

(22) Filed: Dec. 23, 2003

(51) Int. Cl. G06F 3/00

(52) U.S. Cl. 710/52

(57) ABSTRACT

A method and program are disclosed for scheduling operations in a digital processing system. The method includes monitoring one or more operations to be scheduled, sorting the operations based on their respective deadline processing cycles for scheduling, and storing the sorted operations in a queue. The operations are scheduled by adjusting their schedule time based on the updated system resource usage.

### BACKGROUND

The present disclosure generally relates to the field of digital processing systems, and more particularly to behavioral specification therein. Still more particularly, the present disclosure relates to scheduling algorithms that minimize certain behavioral specifications of digital processing systems.

Digital processing systems are constrained by a number of behavioral factors, including data storage and processing time. Data storage requirement is typically inversely proportional to processing time, as both the management complexity thereof and access time generally increase as data storage requirement increases. As such, efficient digital processing system designs attempt to minimize the usage data storage areas with speed as a prime consideration.

One of the methods to improve efficiency in high-level designs is through operation scheduling. Operation scheduling is the process whereby computer operations are arranged such that the number of operation cycles required to complete all operations is minimized.

Operation scheduling is an intractable computational problem. In other words, no algorithm exists that runs in polynomial time and returns an approximate solution that is no more than a certain factor away from the optimal solution. Because the optimal solution is often too prohibitively expensive to find, most high-level designs strike a balance by using heuristics to find a good scheduling solution that is close to the optimal solution but that does not require an exorbitant amount of computing resources to compute. As such, any high-level design essentially faces a trade-off between computational cost and computational performance.

One of the better-known heuristic techniques is high-level synthesis scheduling, whereby the lower bound of an instruction is estimated and a register-transfer mechanism is produced. Lower bound of an instruction is the earliest clock cycle at which the instruction can be issued without corrupting data. Instead of producing all possible designs, synthesis scheduling uses estimation in earlier design stages to eliminate certain designs that either are inferior or violate given constraints. Since the combinatorial variations due to different resource constraints and transformations increase exponentially as estimation is tightened, it is imperative that estimation tools must produce a tight lower bound in order to properly eliminate inferior designs. A loose lower bound may result in a solution far from an optimal solution. Also, any estimation tool must be faster than an actual scheduler or else it delivers no value to the digital processing system.

One method to estimate lower bound is to focus on execution values. First, multi-cycle operations are broken into single-cycle operations, each of whose earliest and latest execution values are determined. By sorting the operations in increasing order of their latest execution values, and then by assigning each operation to the earliest possible time step, thereby satisfying earliest execution values, the lower bound can be found. A proper identification of the lower bound may produce an efficient program running time, given a particular clock cycle, other resource constraints, and resource delays. Under such circumstances, the computational cost varies significantly but is generally high, from O(n²)to O(n³) and above, where O is the cost function and n is the number of operations to be scheduled.

Previous works on lower bound estimation have focused on both cost savings and performance enhancement, but are limited in scope. Certain mathematical models that compute maximum increase in total execution time over all intervals of time-steps are limited in that their methods apply to situations where only homogeneous resources in a multiprocessor computing environment are considered. Improvements thereon have focused on expanding to heterogeneous resource arrays at each interval of time-step. Although these improvements are superior by design, they are computationally very expensive. Other mathematical models estimate lower bound by iterating over all cycles as defined in the critical path, thereby resulting in a very tight lower bound estimation. However, the computational cost is very high. Yet more mathematical models focus on speed, but they are either too trivial or oblivious to other critical issues, such as precedence constraints.

Precedence constraint defines the relationships among a plurality of operations. If a first operation can start only after a second is finished, the second operation is defined to precede the first operation. Certain precedence constraints may be relaxed, as long as no data are corrupted. By loosing such constraints, the time to compute a lower bound solution may be significantly reduced. Such algorithms are known as relaxed scheduling algorithms, wherein each operation is scheduled at the earliest possible time, as long as resource constraints remain satisfied.

Typically, the first step involves reading a directed acyclic graph (DAG) and identifying all resource constraints. In the second step, the release and deadline times for each operation in the DAG are identified using critical path analysis. All release and deadline time pairs are sorted such that the operation with the earlier release time is scheduled first. If two or more operations are schedulable at the same cycle, the one with the earlier deadline will be scheduled first. If there is still a tie, an algorithm will arbitrarily schedule one before the other. By using the aforementioned rule set, operations unscheduled in one operating cycle will be inserted into a ready list of operations for the next cycle. By applying the aforementioned rule set contiguously beginning at the root operation (cycle 0), all operations will eventually be scheduled. To find the operation with the earliest deadline in the said ready list, a heap sort algorithm may be used. As such, the computational cost of such algorithms varies from O(n log n) to O(n²).

A sharper lower bound can be further accomplished by applying the relaxed scheduling algorithm iteratively for each operation, thereby further tightening scheduling ranges. The computational cost of such algorithm is generally O(e*n log n), where e is the number of edges in the DAG.

The cost-performance trade-off in high-level synthesis scheduling is well known. Therefore, there is ample room for further optimization and improvement.

Desirable in the art of digital processing systems design are improved designs that further improve performance/cost ratio, thereby not only improving performance but also saving precious resources.

### SUMMARY

In view of the foregoing, a method and program are disclosed for scheduling operations in a digital processing system. The method includes monitoring one or more operations to be scheduled, sorting the operations based on their respective deadline processing cycles for scheduling, and storing the sorted operations in a queue. The operations are scheduled by adjusting their schedule time based on the updated system resource usage.

Various aspects and advantages will become apparent from the following detailed description, taken in conjunction with the accompanying drawings, illustrating the principles of the disclosure by way of examples.

### BRIEF DESCRIPTION OF THE DRAWINGS

FIG. 1 presents a flow chart illustrating the mechanism of the relaxed scheduling algorithm in accordance with one example of the present disclosure.

FIGS. 2A-2F illustrate one application of the relaxed scheduling algorithm in accordance with one example of the present disclosure.

### DESCRIPTION

In the present disclosure, a method and program are disclosed for scheduling operations in a digital processing system using a relaxed scheduling algorithm.

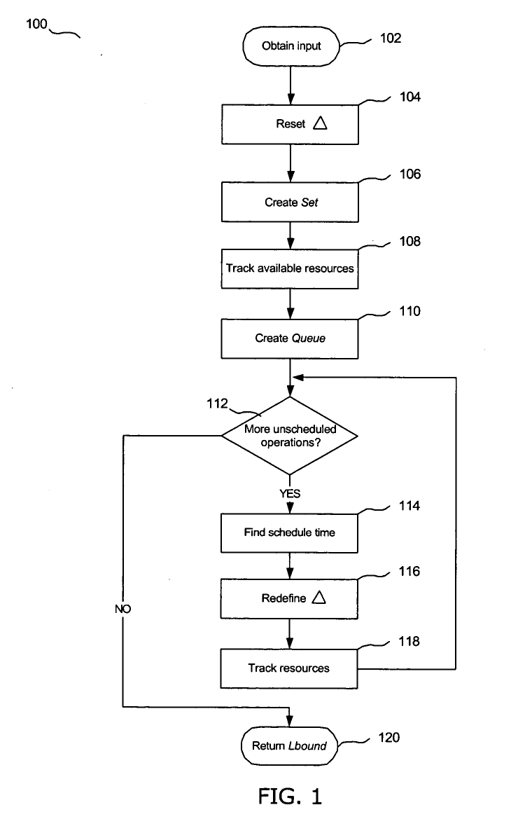

FIG. 1 presents a flow chart 100 illustrating the mechanism of the relaxed scheduling algorithm in accordance with one example of the present disclosure.

In step 102, inputs are fed into the algorithm. The inputs may be a DAG, or an information array thereof. Output may also be defined. For example, the output may be the lower bound, Lbound. The implementation of a relaxed scheduling algorithm Relaxed-Scheduling may begin as follows:

Algorithm Relaxed-Scheduling
Input: basic block DAG G (N, E)
Output: the scheduling lower bound Lbound
   where G is a DAG, and N and E are inputs to G.

In step 104, a variable, Δ, which is used to record the maximum difference between the schedule time of an operation and the said operation's deadline, is reset to zero:
Δ=0

When the algorithm is executed, the value of the variable Δ may change, as it reflects the number of extra cycles over the physical number of operations that is needed to schedule all the operations. The estimated lower bound Lbound is as follows:
Lbound =Δ+release time of the last scheduled operation+1 (Equation 1)
where the extra “1” exists because the first scheduled operation is assumed to be at cycle=0.

In step 106, an array, Set, is created such that each operation op of the complete set of operations, N, that has yet been scheduled will be tracked. For example, Set may be created and initiated as follows:

for each operation op ∈ N
Set[rₒₚ]=−1

endfor

where rₒₚ is the release time for an operation op. If the value of Set[rₒₚ] is negative, then all the operations whose release time is rₒₚ can be scheduled at cycle rₒₚ.

In step 108, available resources are tracked. The relaxed scheduling algorithm Relaxed-Scheduling approaches the scheduling problem by using a disjoint-set data structure. Instead of scheduling operations from cycle 0, this approach will schedule operations one by one according to their deadlines. Since the approach does not iterate from cycle 0 to cycle cp1, where cp is the length of the critical path, a separate array is utilized to manage resource usage at a particular cycle. The implementation to manage resource usage at a particular cycle may appear as follows:

for c = 0 to cp − 1
Resources[c] = available resources at cycle c
endfor

where Resources[c] is the system resource available at cycle c and cp is the length of the critical path.

In step 110, all operations are sorted accordingly and a queue Queue of the operations is created and populated. In a first example, step 110 may be implemented as follows:

```
function Sort-Queue
  Input: N, a set of operations; and Queue, an array
begin
  create two arrays of link lists, named ArrayR and ArrayD
  for each op ∈ N
    append op to ArrayR[rₒₚ]
  endfor
  for c = 0 to cp 1
    for each op in ArrayR[c]
      append op to ArrayD[dₒₚ]
    endfor
  endfor
  for c = 0 to cp − 1
    for each op in ArrayD[c]
      append op to Queue
    endfor
  endfor
  return
end
```

In the first example, the function Sort-Queue takes in as inputs N, which is the complete set of operations, and Queue, an initialized array for storing sorted operations. The function also creates two link lists, named ArrayR and ArrayD that are used to temporarily link to release and deadline data, respectively. First, all operations are appended to ArrayR according to their release time. Then, for each cycle with which the critical path is iterated, operations are appended to ArrayD according to their deadlines. Finally, the operations in ArrayD are copied to Queue, which contains a list of operations sorted, in lexicographical terms, in increasing order of their deadlines. The computational cost of this queue-sorting function is in the order of O(N).

In a second example, step 110 may be implemented as follows:

```
function Sort-Queue
  Input: N, a set of operations; and Queue, an array
begin
  create three arrays of link lists, named ArrayS, ArrayR and ArrayD
  for each op ∈ N
    Rₒₚ = the number of resources consumed by operation op
    append op to ArrayS[Rₒₚ]
  endfor
  for r = R to 1
    for each op in ArrayS[r]
      append op to ArrayR[rₒₚ]
    endfor
  endfor
  for c = 0 to cp − 1
    for each op in ArrayR[c]
      append op to ArrayD[dₒₚ]
    endfor
  endfor
  for c = 0 to cp − 1
    for each op in ArrayD[c]
      append op to Queue
    endfor
  endfor
  return
end
```

The second example is similar to the first example. However, the second example is different in that the second example ensures that in case of a tie, the operation that consumes more resources will be scheduled first. This is made possible by using an additional link list ArrayS, where operations that are sorted according to the number of resources consumed are placed. It is however understood by those skilled in the art that other embodiments of queue-sorting functions may exist, and that the above two examples are merely illustrative examples of how the sort queue function may be designed and implemented.

In step 112, it is decided whether there is another operation that needs to be scheduled. This may be achieved by using a while loop and a variable pointer, which points to the operation in question. If there is another operation that needs to be scheduled, the flow goes to step 114, where schedule time is found using a schedule time finding function Find-Set. For example, the function Find-Set may be implemented as follows:

```
function Find-Set
  Input: i, issue time of operation op
  Output: the set that contains op
begin
  if Set [i] < 0 then
    return i
  else
    return Find-Set(Set[i])
  endif
end
```

The function Find-Set takes in as input i, or a release time of an operation, and returns the actual schedule time for an operation. The function uses the array Set to keep track of operations that can be scheduled. For example, Set[i] keeps track of operations that can be scheduled at cycle i. If the value of Set[i] is negative, then all the operations whose release time is i can be scheduled at cycle i; on the other hand, if the value of Set[i] is positive, then the function will be nested and called recursively as Set[Set[i]] until the schedule time is determined.

After schedule time is found, Δ may be updated in step 116 if the difference between the schedule time and the deadline for this scheduled operation is higher than that for another scheduled operation:
Δ=max (tₒₚ−dₒₚ, Δ)

Whenever an operation is scheduled, the system resources usage will be updated, and the schedule time of each unscheduled operations will be adjusted accordingly. For example, if operation opⱼ is selected from Queue for scheduling, the function Find-Set will compute and return the earliest schedule time for opⱼ. In this case, the schedule time, tₒₚⱼ, will be Find-Set(opⱼ).

In step 118, resources are tracked and must reflect any usage of resources due to the scheduling of the just-scheduled operation:

```
Resources[tₒₚ] = Resources[tₒₚ] − res[op]
if Resources[tₒₚ] = 0 then
  k = the earliest time greater than tₒₚ
    and Resources[k] ≠ 0
  Set[tₒₚ] = k
endif
```

The resource tracker Resources will be updated by removing the resources consumed by opⱼ, or res[opⱼ]. If Resources[opⱼ,] is empty, no more operations will be scheduled at cycle Find-Set(opⱼ), and operations which can be scheduled will have to be merged into the operations which can be scheduled in the next available cycle. This merge may be performed by setting Set[tₒₚⱼ] to k, where k is the first cycle after tₒₚⱼ and provided that Resources[k] is not empty.

The flow goes back to step 112 to decide whether there is another operation that needs to be scheduled. If there is not, the lower bound is computed, as given by Equation 1, and returned in step 120. This may be achieved by using the aforesaid while loop and the aforesaid variable pointer. By piecing together all of the elements as described above, a complete version of the relaxed scheduling algorithm Relaxed-Scheduling may be implemented as follows:

```
Algorithm Relaxed-Scheduling
  Input: basic block DAG G (N, E)
  Output: the scheduling lower bound Lbound
begin
  Δ = 0
  for each operation op ∈ N
    Set[rₒₚ] = −1
  endfor
  for c = 0 to cp − 1
    Resources[c] = available resources at cycle c
  endfor
  Sort-Queue (N, Queue)
  pointer = 0
  while pointer ≠|N|
    op = Queue[pointer]
    pointer = pointer + 1
    tₒₚ = Find-Set (rₒₚ)
    Δ = max (tₒₚ − dₒₚ, Δ)
    Resources[tₒₚ] = Resources[tₒₚ] − res[op]
    if Resources[tₒₚ] = 0 then
      k = the earliest time greater than tₒₚ
        and Resources[k] ≠ 0
      Set[tₒₚ] = k
    endif
  endwhile
  return Δ + rₒₚ+ 1
end
```

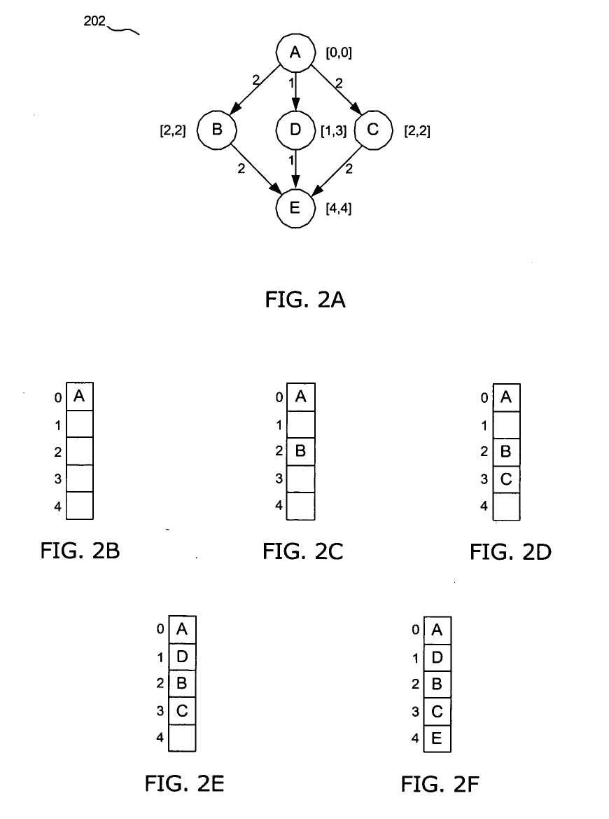

The relaxed scheduling algorithm is applied to a directed acyclic graph 202, as illustrated in FIG. 2A, in accordance with one example of the present disclosure. For simplicity, the processor is a single-issue processor, wherein only one operation can be scheduled at each machine cycle. The graph 202 includes five operations A, B, C, D and E, whose release time and deadline matrices are, respectively, [0,0], [2,2], [2,2], [1,3] and [4,4]. Operation A is the root operation, with no parent, while operation E is the leaf operation, with no children.

Initially, the lower bound of the graph 202 is the length of the critical path length, which is five cycles. Since operation A has the earliest deadline among others, it is scheduled at cycle 0, as illustrated in FIG. 2B. At this stage, Δ is zero because the schedule time for A is equivalent to its deadline. Next, operation B is scheduled at cycle 2, as illustrated in FIG. 2C, since B has the second earliest deadline. At this stage, A remains at zero because the schedule time for B is equivalent to its deadline. After B is scheduled, the available resources at cycle 2 are empty, and thus all the operations that can be scheduled at cycle 2 is now postponed to cycle 3, which is still available. Among the remaining operations, since operation C has the earliest deadline, it is scheduled at cycle 3, as illustrated in FIG. 2D. At this stage, A is set to 1 because the schedule time for C is larger than its deadline by 1. After that, operation D is scheduled at cycle 1, as illustrated in FIG. 2E. It is notable that cycle 1 is also the release time of D. Since the difference between the schedule time for D and its deadline is negative, A maintains at the value when C is scheduled. Finally, operation E is scheduled at cycle 4, as illustrated in FIG. 2F. The lower bound of the graph 202 is thus:

$$Lbound = 4 ( release time of the last scheduled operation ) + 1 ( Δ ) + 1 = 6 cycles$$

The above disclosure provides many different embodiments, or examples, for implementing different features of the disclosure. Specific examples of components, and processes are described to help clarify the disclosure. These are, of course, merely examples and are not intended to limit the disclosure from that described in the claims.

Although illustrative embodiments of the disclosure have been shown and described, other modifications, changes, and substitutions are intended in the foregoing disclosure. Accordingly, it is appropriate that the appended claims be construed broadly and in a manner consistent with the scope of the disclosure, as set forth in the following claims.

1. A method for scheduling operations in a digital processing system, the method comprising:
monitoring one or more operations to be scheduled;
sorting the operations based on their respective deadline processing cycles for scheduling;
storing the sorted operations in a queue; and
scheduling the operations by adjusting their schedule time based on updated system resource usage.

2. The method of claim 1 wherein the monitoring of one or more operations further includes creating an array for monitoring.

3. The method of claim 1 wherein the scheduling further includes:
determining a first schedule time for a first selected operation;
removing system resource used at the scheduled time by the selected operation;
postponing a second selected operation to a second schedule time if it can not be scheduled with sufficient system resource at the first schedule time.

4. The method of claim 1 further comprising maintaining a variable for recording a maximum processing cycle difference between the schedule time and deadline processing cycle for the operations.

5. The method of claim 4 further comprising generating a lower bound value for the scheduled operations.

6. The method of claim 5 wherein the lower bound value is mathematically derived as a summation of the maintained variable, a release time of a last scheduled operation, and the schedule time for an earliest scheduled operation.

7. The method of claim 1 wherein the sorting further includes:
creating a first and second link lists for temporarily linking to data for release time and deadline processing cycles, respectively;
arranging the operations in the first link list according to their release time;
appending the operations in the second link list according to their deadline processing cycles; and
copying the second link list to form the queue.

8. The method of claim 7 further includes in case of a tie when appending the operations in the second link list, scheduling an operation that consumes more resource first.

9. The method of claim 8 further includes maintaining a third link list which includes the operations sorted according to resources consumed.

10. A computer program for scheduling operations in a digital processing system, the program comprising instructions for:
monitoring one or more operations to be scheduled;
sorting the operations based on their respective deadline processing cycles for scheduling;
storing the sorted operations in a queue; and
scheduling the operations by adjusting their schedule time based on updated system resource usage.

11. The program of claim 10 wherein the monitoring one or more operations further includes creating an array for monitoring.

12. The program of claim 10 wherein the scheduling further includes instructions for:
determining a first schedule time for a first selected operation;
removing system resource used at the scheduled time by the selected operation;
postponing a second selected operation to a second schedule time if it can not be scheduled with sufficient system resource at the first schedule time.

13. The program of claim 10 further comprising instructions for maintaining a variable for recording a maximum processing cycle difference between the schedule time and deadline processing cycle for the operations.

14. The program of claim 13 further comprising instructions for generating a lower bound value for the scheduled operations.

15. The program of claim 14 wherein the lower bound value is mathematically derived as a summation of the maintained variable, a release time of a last scheduled operation, and the schedule time for an earliest scheduled operation.

16. The program of claim 10 wherein the instructions for sorting further includes instructions for:
creating a first and second link lists for temporarily linking to data for release time and deadline processing cycles, respectively;
arranging the operations in the first link list according to their release time;
appending the operations in the second link list according to their deadline processing cycles; and
copying the second link list to form the queue.

17. The program of claim 16 further includes in case of a tie when appending the operations in the second link list, instructions for scheduling an operation that consumes more resource.

18. The program of claim 17 further includes instructions for maintaining a third link list which includes the operations sorted according to resources consumed.

19. A method for scheduling operations in a digital processing system, the method comprising:
selecting an operation out of a set of operations from an operation queue based on its deadline;
monitoring a consumption of system resources by the set of operations;
determining an earliest schedule time for the selected operation;
determining available system resource at the determined earliest schedule time based on the system resource consumption of other scheduled operations in the operation queue;
if the system resource is available, placing the operation in the queue according to its schedule time; and
if the system resource is not available, postponing scheduling the selected operation to a predetermined processing cycle in which the system resource becomes available.

20. The method of claim 19 wherein the monitoring further includes removing system resource used at the scheduled time by the selected operation.

21. The method of claim 19 further comprising maintaining a variable for recording a maximum processing cycle difference between the schedule time and deadline processing cycle for the set of operations.

22. The method of claim 21 further comprising generating a lower bound value for the set of operations after they all have been scheduled.

23. The method of claim 22 wherein the lower bound value is mathematically derived as a summation of the maintained variable, a release time of a last scheduled operation, and the schedule time for an earliest scheduled operation.

24. The method of claim 19 further includes sorting the set of operations by:
creating a first and second link lists for temporarily linking to data for release time and deadline processing cycles, respectively;
arranging the operations in the first link list according to their release time;
appending the operations in the second link list according to their deadline processing cycles; and
copying the second link list to form the queue,
wherein in case of a tie when appending the operations in the second link list, an operation that consumes more resource is scheduled first.
